(19) United States
(12) Patent Application Publication
(10) Pub. No.: US 2023/0093152 A1
(43) Pub. Date: Mar. 23, 2023

(54) ELECTRICALLY CONTROLLABLE COMPONENT ASSEMBLY

(71) Applicant: Robert Bosch GmbH, Stuttgart (DE)

(72) Inventors: Andreas Krueger, Buehl (DE); Benjamin Haufe, Obersulm Willsbach (DE); Janos Tamas Csoti, Erligheim (DE); Klaus Lerchenmueller, Rettenberg (DE); Lothar Detels, Burgberg (DE); Patrick Budaker, Drancy (FR); Konstantin Haberkorn, Stuttgart (DE)

(21) Appl. No.: 17/909,330

(22) PCT Filed: Jan. 18, 2021
(86) PCT No.: PCT/EP2021/050926

§ 371 Date: Sep. 2, 2022

(30) Foreign Application Priority Data
Mar. 13, 2020 (DE) 10 2020 203 273.4

(51) Int. Cl. H02K 1/28; H02K 11/225

(52) U.S. Cl. CPC H02K 1/28; H02K 11/225

(57) ABSTRACT

An electrically controllable component assembly and an electronically slip-controllable brake system having such a component assembly. The component assembly has an electric machine including a rotor, a machine shaft connected to a rotor in a torsionally fixed manner, and a signal transducer, revolving with the rotor, of a sensor device for the electronic sensing and evaluation of the angle of rotation of the machine shaft. The signal transducer has first regions and second regions, which are situated in mutual alternation in sequence in the circumferential direction of the signal transducer and differ from one another in their respective electrical conductivity. The signal transducer includes a shaped sheet metal part, which rests in a flush manner against the rotor and is anchored in a torsionally fixed manner to the machine shaft.

### FIELD

The present invention relates to an electrically controllable component assembly.

### BACKGROUND INFORMATION

Electrically controllable component assemblies are used in electronically slip-controllable brake systems of motor vehicles for operating a pressure generator. With the aid of the delivered pressure means whose magnitude is proportional to the delivered volume of pressure means, a brake pressure is built up in wheel brakes of these brake systems. Sensor devices are provided to calculate the displaced volume of pressure means, the sensor devices sensing the angle of rotation of a rotor of an electric motor of the component assembly and conveying the sensed angle of rotation signal to an electronic control device of the vehicle brake system for the further evaluation.

This control device is furthermore suitable for adapting the brake pressure to the slip conditions currently prevailing at the respective associated wheels of the vehicle individually for each wheel. As a result, spinning wheels of a vehicle is able to be prevented, the driving stability of a vehicle can be improved, and braking processes are ultimately able to be carried out as a function of the instantaneous traffic situation and independently of an existing braking desire of a driver.

An electrically controllable component assembly is described in German patent Application No. DE 10 2018 222 842, for example.

This conventional component assembly includes an electrically commutated motor having a rotor as well as a motor shaft which is connected to this rotor in a torsionally fixed manner. The rotor has a conventional design and includes a rotor lamination having multiple magnets situated next to one another in the circumferential direction of the rotor lamination. In the conventional manner, these magnets cooperate with magnets of a stator of the motor so that the rotor with the motor shaft is driven to execute a rotational movement. For this purpose, the stator is accommodated in a motor housing inside which the rotor is mounted in a rotatable manner via the motor shaft.

A sensor device is provided for the quantitative sensing of the rotational movement of the rotor, which is made up of a signal transducer revolving with the rotor and an allocated signal receiver permanently anchored to the motor housing. The signal transducer is fixed in place on the rotor by mechanical connection means such as rivets.

The signal receiver and signal transducer operate according to an inductive measuring principle. To this end, the signal receiver is provided with a field coil and a detector coil, which are swept in alternation by the areas of different electrical conductivity during a rotation of the signal transducer. In response to the change in the electrical conductivity, a variable voltage which characterizes the rotational movement of the signal transducer or the rotor assembly is induced in the detector coil.

Such a direct placement of the signal transducer on the rotor offers the advantage of allowing for a short design of the component assembly in the direction of a longitudinal axis of its motor shaft. In addition, relatively precise sensing of the actual angle of rotation of the rotor is possible because no inertia-related torsion of the motor shaft resulting from the acceleration or deceleration forces acting at the rotor occurs between the signal transducer and the rotor.

Nevertheless, the circuit board with its wing-shaped coating is relatively expensive in its production, and additional working steps for fastening the circuit board to the rotor are required. If rivets or screws are used as the connection means, then this leads to an increase in the number of components and the weight and thus in the moment of inertia of the rotor. Finally, relatively high demands as far as the concentricity of this circuit board with respect to a longitudinal axis of the motor shaft is concerned must be observed when the circuit board is mounted on the rotor in order to prevent any adverse effect on the precision of the rotational angle sensing.

### SUMMARY

An electrically controllable component assembly according to the present invention may offer the advantage that the signal transducer is able to be produced more cost-effectively than in the cited related art. The torsionally fixed fastening of the signal transducer to the machine shaft can be realized at a minimal technical expenditure. Additional fastening means and working steps for anchoring the signal transducer to the rotor are saved. According to an example embodiment of the present invention, the signal transducer includes a shaped sheet metal part, which is flush-mounted against the rotor and fixed in place on the machine shaft in a torsionally fixed manner. The positioning of the signal transducer on the rotor in a flush-mounted manner makes it possible to accommodate the signal transducer in the space of the electric machine, and the length of the component assembly in the direction of the longitudinal axis of the machine shaft remains compact without any changes.

Additional advantages and advantageous further refinements of the present invention are disclosed herein.

In an advantageous further refinement of the present invention, the torsionally fixed fastening of the signal transducer to the machine shaft is implemented in the form of a press-fit connection. This makes it possible to save separate fastening means such as screws or rivets and the fastening process is able to be carried out and monitored in an automated manner.

According to an example embodiment of the present invention, it has shown to be especially advantageous to implement this press-fit connection in the form of a serration. In this case, at least one radially projecting serration is provided at the periphery of the machine shaft, which extends in the direction of a longitudinal axis of the machine shaft and displaces material in a region of a hub of the signal transducer when the signal transducer is anchored to the machine shaft. As a result, a frictional and simultaneously keyed connection is created between the components, which prevents undesired relative movements between the signal transducer and the rotor in an especially effective manner, in particular in the hub region of the signal transducer.

In one especially advantageous further refinement of the present invention, in addition to the torsionally fixed fastening to the machine shaft, the signal transducer is fixed in place on the rotor. This makes it possible to prevent relative movements or deformations of the signal transducer in the circumferential direction and also in the direction of the longitudinal axis of the machine shaft. Possible deformations may otherwise come about due to the onset of inertial forces in response to changes in the rotational speed due to operating conditions.

For instance, a frictional connection may be provided between the signal transducer and the rotor. The latter can be realized by an elastic preloading means, which is situated on the machine shaft on a side of the signal transducer facing away from the rotor and presses the signal transducer against the rotor at a preloading force which is acting in the direction of the longitudinal axis of this machine shaft. The preloading element ensures the flush contact of the signal transducer at the rotor and induces a frictional force between the components.

Instead of a frictional connection for avoiding relative movements in the circumferential direction, it is also possible to provide a keyed connection between the signal transducer and the rotor. This is advantageously achieved with the aid of a tab or stud, which is developed on the shaped sheet metal part of the transducer and projects in the direction of the longitudinal axis of the machine shaft and penetrates an assigned opening of the rotor.

Via a plastic deformation of the end of the tab or stud protruding into the opening, the signal transducer and rotor are advantageously firmly connectable to one another in the sense of press-fit caulking or riveting. In a firm connection, relative movements in the circumferential direction and simultaneously in the direction of the longitudinal axis of the machine shaft are able to be prevented for the most part and the precision of the measuring result can be further improved.

### BRIEF DESCRIPTION OF THE DRAWINGS

Exemplary embodiments of the present invention are shown in the figure and are described in detail in the following description.

FIG. 1 shows a three-dimensional representation of a rotor module according to an example embodiment of the present invention.

FIG. 2 shows a machine shaft and a signal transducer, which are connected to each other by a conventional press-fit connection, according to an example embodiment of the present invention.

FIG. 3 shows a perspective representation of a machine shaft having serrations developed thereon, according to an example embodiment of the present invention.

FIG. 4 shows a preloading element in a cross-section, which presses the signal transducer against the rotor, according to an example embodiment of the present invention.

FIG. 5 shows a rotor having receiving openings for tabs or studs projecting from the cross-sectional surface of a signal transducer, according to an example embodiment of the present invention.

FIG. 6 schematically and in a simplified manner shows a tab which projects from the cross-sectional surface of the signal transducer and protrudes into an opening of the rotor, according to an example embodiment of the present invention.

In the individual figures, the same reference numerals have been used for matching components.

### DETAILED DESCRIPTION OF EXAMPLE EMBODIMENTS

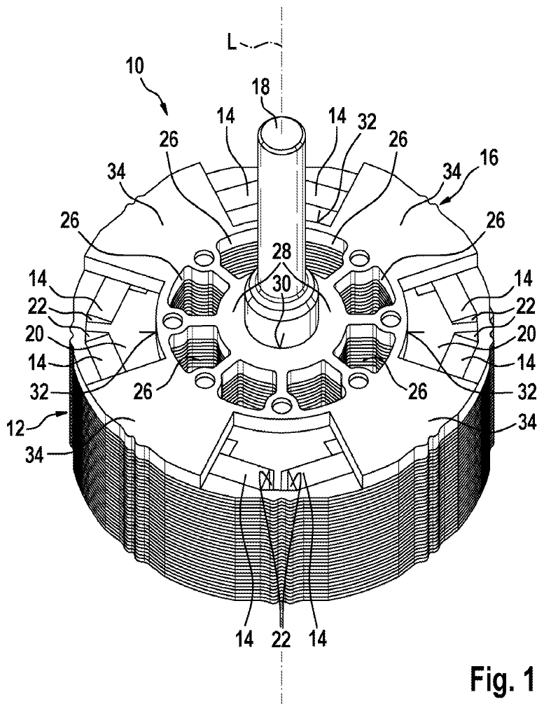

Rotor 10 of an electric machine shown in FIG. 1 includes a rotor lamination 12, a plurality of magnets 14, which are situated next to one another on rotor laminations 12 along an outer periphery, a signal transducer 16 of a sensor device, resting flush against an end face of rotor lamination 12, for sensing an angle of rotation of rotor 10 as well as a machine shaft 18, which carries rotor lamination packet 12 with its magnets 14 and projects through an allocated shaft opening 30 on signal transducer 16. Machine shaft 18 and rotor 10 are connected to one another in a torsionally fixed manner.

Rotor lamination packet 12 is made up of a plurality of rotor laminations 20 which are stacked on top of one another and attached to one another. These rotor laminations 20 essentially are flat, largely circular formed parts of a magnetically soft material, also known as electrical steel. Individual rotor laminations 20 are fastened to one another, have a mutually congruent outer contour, and are provided with uninterrupted recesses 22 which accommodate magnets 14 of rotor 10 on the inside.

According to the present invention, transducer 16 as shown in FIG. 1 is also developed as a formed sheet metal part. This part is made from a metallic material, in particular from the same material as rotor laminations 20 of rotor 10, and it has a plurality of recesses 32 in the region along its outer periphery, which are set apart from one another in the circumferential direction by wing-shaped sections 34 in each case. Recesses 32 form electrically non-conductive regions, and wing-shaped sections 34 form electrically conductive regions of signal transducer 16. For instance, recesses 32 are open toward the periphery of the shaped sheet metal part, their geometrical form also largely corresponding to the geometrical form of wing-shaped sections 34 by way of example.

Radially toward the inside, recesses 32 or wing-shaped sections 34 of signal transducer 16 are adjoined by an annular region provided with cutouts 26, which are situated next to one another in the circumferential direction. Cutouts 26 surround a hub region 28 of signal transducer 16 featuring a shaft channel 30 developed in the center of this hub region 28 for the insertion of machine shaft 18.

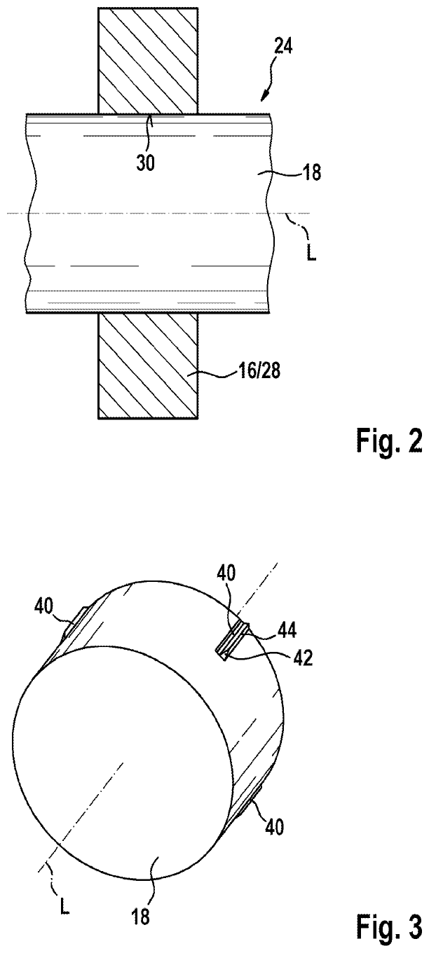

According to the present invention, signal transducer 16 rests against rotor 10 in a flush manner and is furthermore mounted in a torsionally fixed manner on machine shaft 18. By way of example, the torsionally fixed mounting is implementable in the form of a conventional press-fit connection 24. In a first exemplary embodiment of such a press-fit connection 24 shown in FIG. 2, machine shaft 18 as well as shaft channel 30 have a cylindrical cross-section in hub region 28 of signal transducer 16. The outer diameter of machine shaft 18 is larger than the inner diameter of shaft channel 30 of signal transducer 16 so that the oversize that exists between the two components induces a radial preloading force when the components are joined to one another, by which signal transducer 16 is anchored to machine shaft 18 in a torsionally fixed manner.

A serration is used in a second, alternative exemplary embodiment of a press-fit connection between signal transducer 16 and machine shaft 18. For this purpose, as illustrated in FIG. 3 by way of example, a plurality of serrations 40 are developed at regular intervals along the periphery of machine shaft 18, these serrations radially projecting relative to each other and extending in the direction of a longitudinal axis L of this machine shaft 18. Serrations 40 extend from one end of machine shaft 18 to rotor 10 situated on the machine shaft 18; signal transducer 16 is situated in the region of these serrations 40 on machine shaft 18. Serrations 40 have joining chamfers 42 at their end facing away from rotor 10, via which signal transducer 16 centers itself when mounted on machine shaft 18 via its shaft channel 30. In the region of the maximum height of serrations 40, a sharply tapering tooth head 44 is formed by way of example, so that respective serration 40 displaces material of shaft channel 30 of signal transducer 16 during the joining process without dislodging shavings. The cross-sectional form of serration 40 is able to be specified in an application-specific manner.

In the pressed-on state of signal transducer 16 on machine shaft 18, the components are thus connected to one another in a relatively rigid manner by a combination of a frictional and a keyed connection. Such a connection exhibits an extremely robust behavior with regard to relative movements in the circumferential direction of machine shaft 18 even under changing environmental conditions.

In one advantageous further refinement of the present invention, in addition to the described torsionally fixed fastening to machine shaft 18, signal transducer 16 is fixed in place on rotor 10. This makes it possible to further counteract relative movements in the circumferential direction, which are undesired because of their adverse effect on the measuring result. The fastening of signal transducer 16 to rotor 10 may include a frictional and/or a keyed connection.

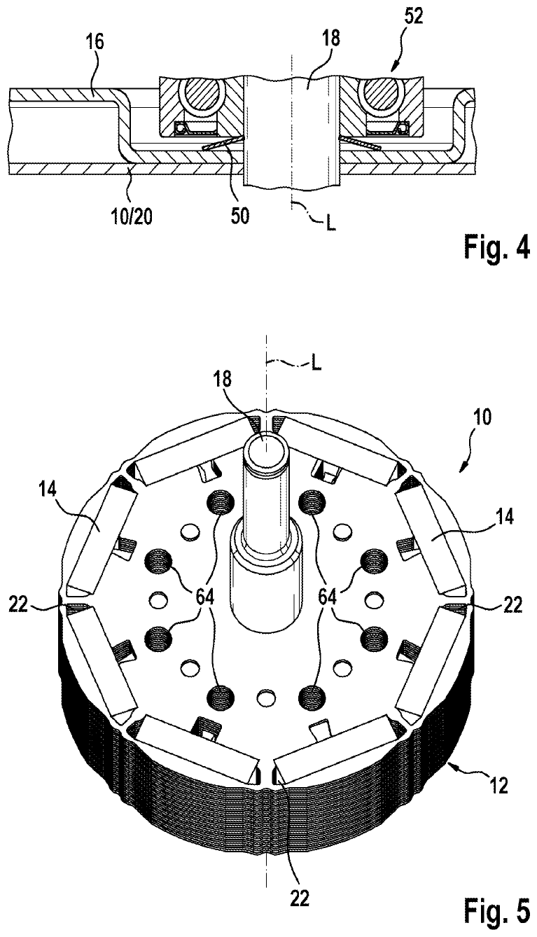

One example of a frictional connection between signal transducer 16 and rotor 10 is illustrated in FIG. 4. This frictional connection is achieved with the aid of an elastic preloading element 50, which is situated on machine shaft 18 on the side of signal transducer 16 facing away from rotor 10. A disk spring is preferably used as a preloading element 50, which is supported on signal transducer 16 on one side and on a rolling bearing 52 supporting machine shaft 18 in the machine housing on the opposite side. The distance between rolling bearing 52 and signal transducer 16 is selected in such a way that the inserted preloading element 50 loads signal transducer 16 by an axial force acting in the direction of the longitudinal axis L of machine shaft 18 in the direction of a rotor lamination 20 of rotor 10. On the one hand, this axial force ensures that signal transducer 16 is securely held in flush contact against rotor 10 under operational conditions, and it induces a frictional force between signal transducer 16 and rotor 10 on the other hand, which potentially counteracts relative movements between the components taking place in the circumferential direction. In the illustrated example, transducer 16 is implemented as a three-dimensional structure having a bowl- or cup-shaped cross-section, for example, but this does not necessarily preclude a flat or largely two-dimensional shape of signal transducer 16.

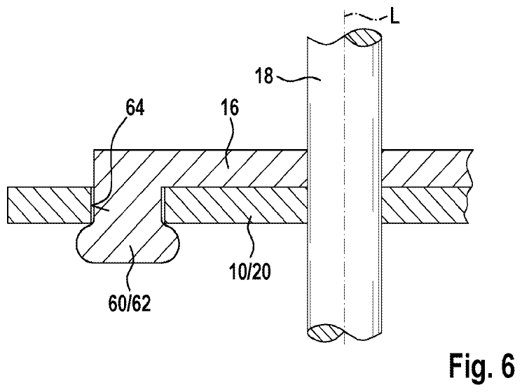

FIGS. 5 and 6 show a variant in which signal transducer 16 and rotor 10 are connected to each other by a keyed connection. To this end, a tab 60 is developed on signal transducer 16, which projects at a right angle from the cross-sectional surface of signal transducer 16 and thus is coaxially aligned with longitudinal axis L of machine shaft 18. Tab 60 is situated on the side of signal transducer 16 facing rotor 10 and, by way of example, is able to be developed in the form of a U-shaped cutout on the shaped sheet metal part of signal transducer 16, the inner part of this cutout being subsequently bent.

A receiving opening 64 is developed on rotor 10, which is allocated to tab 60 or into which tab 60 extends when signal transducer 16 is resting against rotor 10 in a flush manner. If signal transducer 16 were not already situated on machine shaft 18 in a torsionally fixed manner anyway, tab 60 would thus form a driver with the aid of which the rotational movement of rotor 10 would be transmittable to signal transducer 16. It is of course possible to distribute a plurality of such tabs 60 along the cross-section of signal transducer 16. FIG. 5 shows a rotor 10 provided with a plurality of receiving openings 64 to accommodate tabs 60.

Instead of tabs 60, studs 62, which likewise project from the cross-sectional surface at a right angle, may be formed on the signal transducer as an alternative. Such studs, for example, can be developed on the signal transducer with the aid of a punch and die using forming and molding technology. This connection technique is also known as clinching or Tox clinching among experts.

Modifications or supplementations of the described exemplary embodiments are of course possible without deviating from the basic idea of the present invention, disclosed herein.

In this context it should be mentioned that the ends of tabs 60 or studs 62 protruding into openings 64 of rotor 10 are able to be plastically deformed after signal transducer 16 has come to rest against rotor 10 in a flush manner. To this end, for example, a punch is introduced into receiving opening 64 of rotor 10 from the end situated opposite transducer 16. In the interior of rotor 10, the free end of tab 60 is then bent or studs are axially caulked with the aid of this punch. In this way, a firm connection is able to be realized between signal transducer 16 and at least one rotor lamination 20 of rotor 10. The latter at least largely precludes both radially directed relative movements, i.e., movements taking place in the circumferential direction of machine shaft 18, and axially directed relative movements, i.e., movements between signal transducer 16 and rotor 10 in the direction of longitudinal axis L of machine shaft 18, which means that even more precise measuring results are achievable with regard to the angle of rotation of rotor 10.

1-9 (canceled)

10. An electrically controllable component assembly for actuating a pressure generator of an electronically slip-controllable vehicle brake system, comprising:
an electronically commutated motor, having a rotor executing a rotational movement, and a machine shaft, which is connected to the rotor in a torsionally fixed manner, and a signal transducer, which revolves with the rotor, of a sensor device configured to sense an angle of rotation of the rotor, first regions and second regions being developed on the signal transducer, which are positioned in mutual alternation in sequence with one another in a circumferential direction of the signal transducer and which differ from one another in their electrical conductivity;
wherein the signal transducer includes a shaped sheet metal part, which is flush-mounted against the rotor and is fixed in place on the machine shaft in a torsionally fixed manner.

11. The component assembly as recited in claim 10, wherein the torsionally fixed fastening of the signal transducer and the machine shaft is a press-fit connection.

12. The component assembly as recited in claim 11, wherein the press-fit connection includes a serration, in which at least one radially projecting serration is provided on a periphery of the machine shaft, which extends in a direction of a longitudinal axis of the machine shaft and is configured to displace material of a wall of a shaft channel of the signal transducer when the signal transducer is fixed to the machine shaft.

13. The component assembly as recited in claim 10, wherein the signal transducer is fixed in place by a frictional and/or a keyed connection on the rotor in addition to the torsionally fixed fastening to the machine shaft.

14. The component assembly as recited in claim 13, wherein the frictional connection between the signal transducer and the rotor is induced using an elastic preloading element, which is situated on the machine shaft on a side of the signal transducer facing away from the rotor and presses the signal transducer against the rotor at a preloading force acting in a direction of a longitudinal axis of the machine shaft.

15. The component assembly as recited in claim 13, wherein the keyed connection between the signal transducer and the rotor has a tab, which is developed on the shaped sheet metal part of the signal transducer and projects in a direction of a longitudinal axis of the machine shaft and protrudes into an associated receiving opening of the rotor.

16. The component assembly as recited in claim 15, wherein an end of the tab protruding into the receiving opening is plastically deformed.

17. The component assembly as recited in claim 15, wherein an end of the tab protruding into the receiving opening is bent.

18. The component assembly as recited in claim 13, wherein the keyed connection between the signal transducer and the rotor has a stud, which is developed on the shaped sheet metal part of the transducer and projects in a direction of a longitudinal axis of the machine shaft and protrudes into an associated receiving opening of the rotor.

19. The component assembly as recited in claim 18, wherein an end of the stud protruding into the receiving opening is plastically deformed.

20. The component assembly as recited in claim 19, wherein an end of the stud protruding into the receiving opening is axially caulked.
